(19) United States
(12) Patent Application Publication
(10) Pub. No.: US 2017/0171751 A1
(43) Pub. Date: Jun. 15, 2017

(54) METHOD FOR ALLOCATING AE ID IN WIRELESS COMMUNICATION SYSTEM

(71) Applicant: LG ELECTRONICS INC., Seoul (KR)

(72) Inventors: Seongyun KIM, Seoul (KR); Seungkyu PARK, Seoul (KR); Hongbeom AHN, Seoul (KR); Seungmyeong JEONG, Seoul (KR); Heedong CHOI, Seoul (KR)

(73) Assignee: LG ELECTRONICS INC., Seoul (KR)

(21) Appl. No.: 15/039,349

(22) PCT Filed: Nov. 26, 2014
(86) PCT No.: PCT/KR2014/011411

§ 371 Date: May 25, 2016

Related U.S. Application Data
(60) Provisional application No. 61/908,755, filed on Nov. 26, 2013.
(60) Provisional application No. 61/927,497, filed on Jan. 15, 2014.
(60) Provisional application No. 62/010,457, filed on Jun. 11, 2014.

(51) Int. Cl. H04W 12/06; H04W 4/00

(52) U.S. Cl. CPC H04W 12/06; H04W 4/005

(57) ABSTRACT

A method for allocating a user-specific application identifier in a wireless communication system, according to one embodiment of the present invention, is carried out by an M2M apparatus and may comprises the steps of: receiving user information from a user; transmitting, to a peer M2M device, a request message including a user-specific token and an application identifier based on the user information, to allocate the user-specific application identifier; and receiving, from the peer M2M device, a reply message including the user-specific token and the user-specific application identifier which has been allocated based on the application identifier.

### TECHNICAL FIELD

The present invention relates to a method of allocating an AE ID in a wireless communication system and an apparatus therefor.

### BACKGROUND ART

As we are entering the age of ubiquitous, an M2M (machine to machine) communication technology is in the spotlight. Study on the M2M communication technology is in progress by many SDOs (standardization development organizations) including TIA, ATIS, ETSI, oneM2M and the like. In M2M environment, communication is performed among various M2M-related applications (network application/gateway application/device application) and an entity managing an M2M server part (e.g., a common service entity (CSE)) and an entity managing a network side application (e.g., a network application) may be different from each other.

In M2M environment, a user identifier for identifying a user is not used. Hence, one ID (identifier) is assigned to a specific application and an authentication procedure is performed using the ID.

Yet, if an authentication procedure is performed using an ID for a legacy application in M2M environment, although it is able to identify an application, it is unable to identify an individual user. If a plurality of users use a user side specific application (e.g., AE (application entity)), it is difficult to identify an individual user using an ID for the AE.

Therefore, the present invention intends to propose a method capable of identifying and authenticating an individual user in M2M environment.

### DISCLOSURE OF THE INVENTION

### Technical Task

The present invention intends to propose a procedure for identifying and authenticating an individual user in a wireless communication system.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of assigning a user-specific application identifier in a wireless communication system, the method performed by an M2M (machine-to-machine) device and including receiving user information from a user, transmitting a request message including a user-specific token based on the user information and an application identifier to a peer M2M device, the request message for assigning the user-specific application identifier, and receiving a response message including the user-specific application identifier, which is assigned based on the user-specific token and the application identifier, from the peer M2M device.

Additionally or alternatively, a unique user-specific application identifier may be assigned according to a user-specific token included in the request message.

Additionally or alternatively, if a user-specific token identical to a user-specific token associated with a previously assigned user-specific application identifier is included in the request message, a user-specific application identifier identical to the previously assigned user-specific application identifier may be assigned.

Additionally or alternatively, if a user-specific token identical to a user-specific token associated with a previously assigned user-specific application identifier is included in the request message, a user-specific application identifier different from the previously assigned user-specific application identifier may be assigned.

Additionally or alternatively, the user-specific application identifier may be used for authenticating or access controlling a request of the M2M device.

To further achieve these and other advantages and in accordance with the purpose of the present invention, according to a different embodiment, a method of assigning a user-specific application identifier in a wireless communication system, the method performed by an M2M (machine-to-machine) device and including receiving a request message including a user-specific token based on user information of a user and an application identifier from a peer M2M device, the request message being for assigning the user-specific application identifier, assigning the user-specific application identifier based on the user-specific token and the application identifier, and transmitting a response message including the assigned user-specific application identifier to the peer M2M device.

Additionally or alternatively, a unique user-specific application identifier may be assigned according to a user-specific token included in the request message.

Additionally or alternatively, if a user-specific token identical to a user-specific token associated with a previously assigned user-specific application identifier is included in the request message, a user-specific application identifier identical to the previously assigned user-specific application identifier may be assigned.

Additionally or alternatively, if a user-specific token identical to a user-specific token associated with a previously assigned user-specific application identifier is included in the request message, a user-specific application identifier different from the previously assigned user-specific application identifier may be assigned.

Additionally or alternatively, the user-specific application identifier may be used for authenticating or an access controlling a request of the M2M device.

To further achieve these and other advantages and in accordance with the purpose of the present invention, according to a further different embodiment, an M2M (machine-to-machine) device configured to process a request message in a wireless communication system including an RF (radio frequency) unit and a processor configured to control the RF unit, the processor configured to receive user information from a user, transmit a request message including a user-specific token based on the user information and an application identifier to a peer M2M device, the request message being for assigning a user-specific application identifier, and receive a response message including the user-specific application identifier, which is assigned based on the user-specific token and the application identifier, from the peer M2M device.

To further achieve these and other advantages and in accordance with the purpose of the present invention, according to a further different embodiment, an M2M (machine-to-machine) device configured to process a request message in a wireless communication system including an RF (radio frequency) unit and a processor configured to control the RF unit, the processor configured to receive a request message including a user-specific token based on user information of a user and an application identifier from a peer M2M device to assign a user-specific application identifier, assign the user-specific application identifier based on the user-specific token and the application identifier, and transmit a response message including the assigned user-specific application identifier to the peer M2M device.

The aforementioned solutions are just a part of embodiments of the present invention. Various embodiments to which technical characteristics of the present invention are reflected can be drawn and understood based on detail explanation on the present invention to be described in the following by those skilled in the corresponding technical field.

### Advantageous Effects

According to one embodiment of the present invention, it is able to enhance efficiency of identifying or authenticating an individual user for a specific M2M service in a wireless communication system.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for a functional structure of an M2M communication system;

FIG. 2 is a diagram for a configuration supported by an M2M communication system based on an M2M functional structure;

FIG. 3 is a diagram for a common service function provided by an M2M communication system;

FIG. 4 is a diagram for a resource structure existing in an M2M application service node and an M2M infrastructure node;

FIG. 5 is a diagram for a resource structure existing in an M2M application service node (e.g., M2M device) and an M2M infrastructure node;

FIG. 6 is a diagram for a procedure of exchanging a request message and a response message used in an M2M communication system;

FIG. 7 is a diagram for a procedure of transmitting a request using an AE ID differently allocated according to a user;

FIG. 8 is a flowchart for a method of performing an access control for a specific request message according to one embodiment of the present invention;

FIG. 9 is a flowchart for an AE ID allocation request and response procedure according to one embodiment of the present invention;

FIG. 10 is a flowchart for an AE ID allocation request and response procedure according to one embodiment of the present invention;

FIG. 11 is a flowchart for an AE ID allocation procedure for a user and an access control procedure via the AE ID allocation procedure according to one embodiment of the present invention;

FIG. 12 is a flowchart for an access authority allocation procedure performed through interworking with an access authority allocation entity after an AE ID for a user is allocated according to one embodiment of the present invention;

FIG. 13 is a block diagram for a device configured to implement embodiment(s) of the present invention.

### BEST MODE

### Mode for Invention

Reference will now be made in detail to the preferred embodiments of the present invention, examples of which are illustrated in the accompanying drawings. The following detailed description of the invention includes details to aid in full understanding of the present invention. Those skilled in the art will appreciate that the present invention can be implemented without these details.

In some cases, to prevent the concept of the present invention from being obscured, structures and apparatuses of the known art will be omitted, or will be shown in the form of a block diagram based on main functions of each structure and apparatus. In addition, wherever possible, the same reference numbers will be used throughout the drawings and the specification to refer to the same or like parts.

In the present disclosure, devices for device-to-device communication, that is, M2M devices, may be fixed or mobile and include devices which communicate with a server for device-to-device communication, that is, an M2M server to transmit/receive user data and/or various types of control information. The M2M devices may be referred to as terminal equipment, mobile stations (MSs), mobile terminals (MTs), user terminals (UTs), subscriber stations (SSs), wireless devices, personal digital assistants (PDA), wireless modems, handheld devices and the like. In the present invention, the M2M server refers to a fixed station which communicates with M2M devices and/or other M2M servers, and exchanges various types of data and control information with M2M devices and/or other M2M servers by communicating with the M2M devices and/or other M2M servers.

A description will be given of technology associated with the present invention.

M2M Applications

These are applications that execute service logic and use a common service entity (CSE) accessible through an open interface. The M2M applications can be installed in an M2M device, an M2M gateway or an M2M server.

M2M Service

This is a set of functions that can be used by the M2M CSE through standardized interfaces.

oneM2M defines a common M2M service framework (or service platform, CSE or the like) for various M2M applications (or application entities (AEs)). M2M applications can be considered as software implementing service logic such as e-Health, City Automation, Connected Consumer and Automotive. The oneM2M service framework includes functions commonly necessary to implement various M2M applications. Accordingly, it is possible to easily implement various M2M applications using the oneM2M service framework without configuring frameworks necessary for the respective M2M applications. This can integrate M2M markets currently divided into many M2M verticals, such as smart building, smart grid, e-Heath, transportation and security, and thus remarkable growth of the M2M markets is expected.

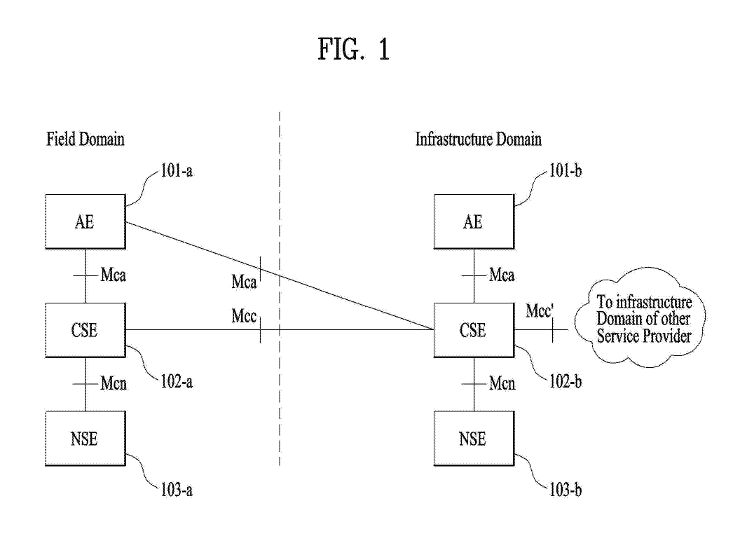

FIG. 1 illustrates the architecture of an M2M communication system. Each entity will now be described.

Application entity (AE, 101): Application entity provides application logic for end-to-end M2M solutions. Examples of the application entity include fleet tracking application, remote blood sugar monitoring application, remote power metering and controlling application.

Common service entity (CSE, 102): CSE comprises the set of “service functions” that are common to M2M environments and specified by oneM2M. Such service functions are exposed to AEs and other CSEs through reference points X and Y and used by the AEs and other CSEs. The reference point Z is used for accessing underlying network service entities.

Examples of the service functions provided by the CSE include data management, device management, M2M subscription management and location service. These functions can be logically classified into common service functions (CSFs). Some CSFs in the CSE are mandatory and some may be optional. Further, some functions in the CSFs are mandatory and some functions may be optional (e.g. some of application software installation, firmware update, logging and monitoring functions in “device management” CSF are mandatory functions and some are optional functions.)

Underlying network service entity (NSE, 103): provides services to the CSEs. Examples of such services include device management, location services and device triggering. No particular organization of the NSEs is assumed. Note: underlying networks provide data transport services between entities in the oneM2M system. Such data transport services are not included in the NSE.

The reference points shown in FIG. 1 will now be described.

Mca Reference Point

This is the reference point between an AE and a CSE. The Mca reference point allows the CSE to communicate with the AE such that the AE can use the services provided by the CSE.

The services provided through the Mca reference point are dependent on the functionality supported by the CSE. The AE and the CSE may or may not be co-located within the same physical entity.

Mcc Reference Point

This is the reference point between two CSEs. The Mcc reference point allows a CSE to use the services of another CSE in order to fulfill needed functionality. Accordingly, the Mcc reference point between two CSEs is supported over different M2M physical entities. The services offered via the Mcc reference point are dependent on the functionality supported by the CSEs.

Mcn Reference Point

This is the reference point between a CSE and an NSE. The Mcn reference point allows a CSE to use the services (other than transport and connectivity services) provided by the NSE in order to fulfill the needed functionality. It means services other than simple service such as transport and connectivity, for example, services such as device triggering, small data transmission and positioning.

Mcc′ Reference Point

This is the reference point is used for communication between CSEs respectively belongs to different M2M service providers. Mcc′ references point is similar to Mcc reference point in respect of connecting CSEs each other, but Mcc′ reference point expands Mcc reference point to different M2M service providers while Mcc reference point is limited to communication in a single M2M service provider.

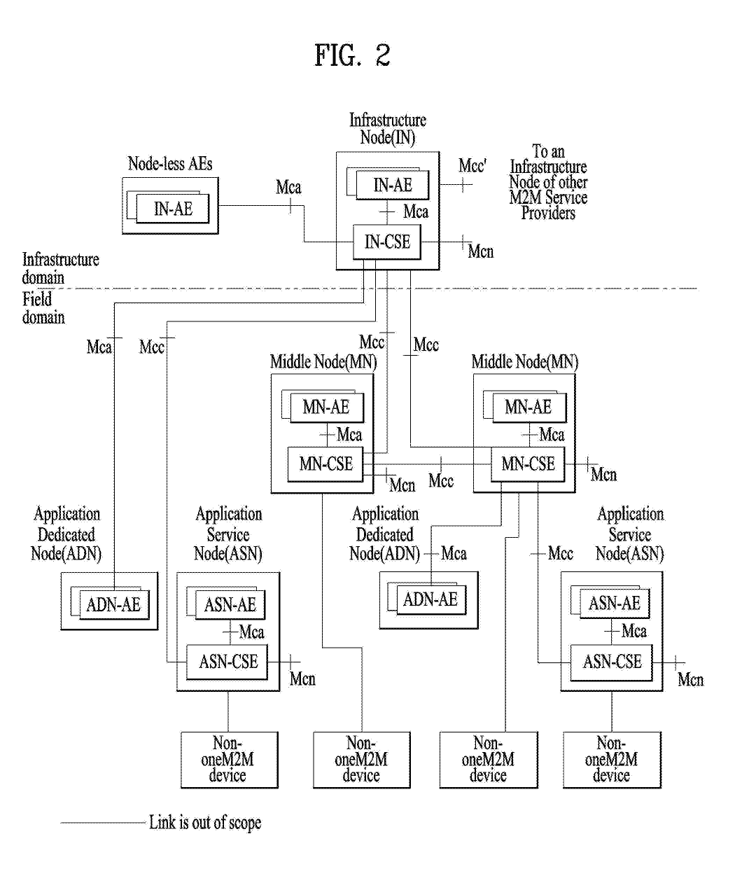

FIG. 2 illustrates compositions supported by M2M communication system based on the architecture. The M2M communication system may support more various compositions without being limited to the illustrated compositions. A concept, which is called to node, important for understand the illustrated compositions will be explained.

Application Dedicated Node (ADN): An application dedicated node is a node that contains at least one M2M application and does not contain a CSE. The ADN can communicate over an Mca reference point with one middle node or one infrastructure node. The ADN can be present in an M2M device.

Application Service Node (ASN): An application service node is a node that contains at least one CSE and has at least one M2M application. The ASN can communicate over a Mcc reference point with one middle node or one infrastructure node. The ASN can be present in an M2M device.

Middle Node (MN): A middle node is a node that contains at least one CSE and may contain M2M applications. The middle node communicates over a Mcc references point with at least two nodes belonging to the following different category:
one or more ASNs;
one or more middle nodes (MNs); and
one infrastructure structure.

The MN can be connected with the ADN through an Mca reference point. The MN can be present in an M2M gateway.

Infrastructure Node (IN): An infrastructure node is a node that contains one CSE and may contain application entities (AEs). The IN can be present in M2M server.

The IN communicates over a Mcc reference point with either:
one or more middle nodes; and/or
one or more application service nodes.

The IN may communicate with one or more ADNs over one or more Mca reference points.

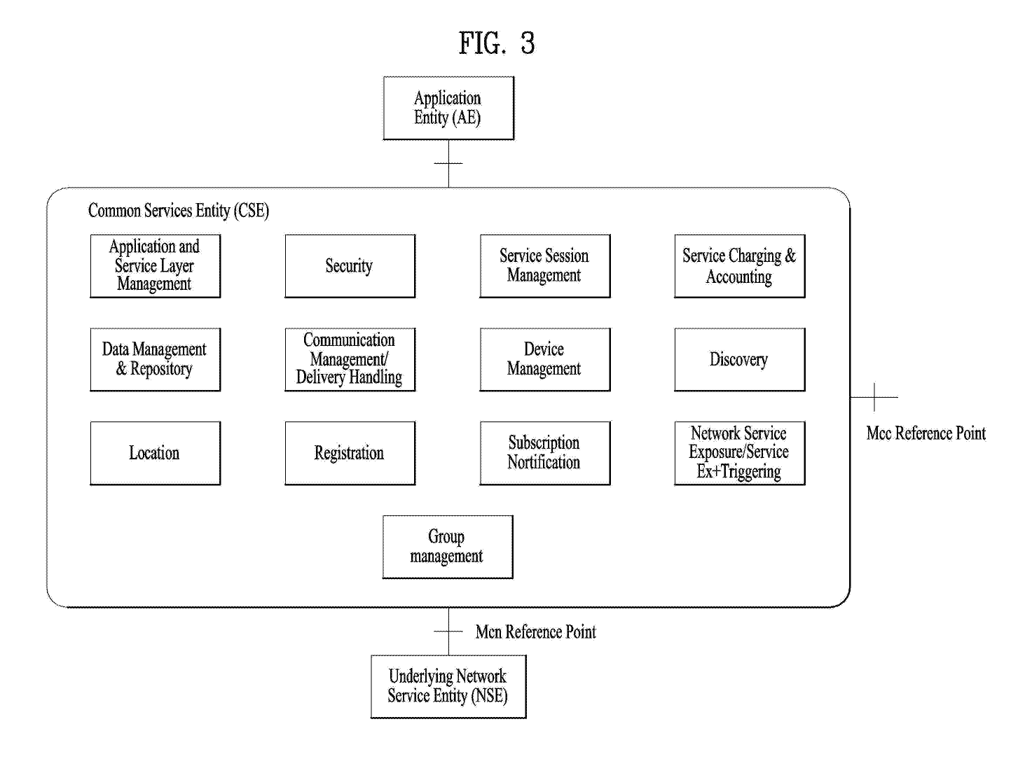

FIG. 3 illustrates M2M service functions in the M2M communication system.

M2M service functions (i.e. common service functions) provided by the oneM2M service framework include “Communication Management and Delivery Handling”, “Data Management and Repository”, “Device Management”, “Discovery”, “Group Management”, “Addressing and Identification”, “Location”, “Network Service Exposure, Service Execution and Triggering”, “Registration”, “Security”, “Service Charging and Accounting”, “Session Management” and “Subscription and Notification.”, as shown in FIG. 3.

A brief description will be given of each M2M service function.

Communication Management and Delivery Handling (CMDH): this provides communications with other CSEs, AEs and NSEs and delivers messages.

Data Management and Repository (DMR): this enables M2M applications to exchange and share data.

Device Management (DMG): this manages M2M devices/gateways. Specifically, the device management function includes installation and setting of applications, determination of set values, firmware update, logging, monitoring, diagnostics, topology management, etc.

Discovery (DIS): this discovers resources and information based on conditions.

Group Management (GMG): this processes a request related to a group that may be generated by grouping resources, M2M devices or gateways.

Addressing and Identification (AID): this identifies and addresses physical or logical resources.

Location (LOC): this enables M2M applications to obtain position information of an M2M device or gateway.

Network Service Exposure, Service Execution and Triggering (NSE): this enables communication of an underlying network and use of functions provided by the underlying network.

Registration (REG): this handles registration of an M2M application or another CSE with a specific CSE. Registration is performed in order to use M2M service functions of the specific CSE.

Security (SEC): this performs handling of sensitive data such as a security key, association establishment, authentication, authorization, identity protection, etc.

Service Charging and Accounting (SCA): this provides a charging function to CSEs.

Session Management (SM): this manages an M2M session for end-to-end communication.

Subscription and Notification (SUB): this notifies change of a specific resource when the change of the specific resource is subscribed.

The M2M service functions are provided through CSE, and AE (or, M2M applications) may use through Mca reference point, or other CSE may use the M2M service functions through Mcc reference point. Also, the M2M service functions may be operated synchronized with underlying network (or underlying network service entity (NSE) such as 3GPP, 3GPP2, Wi-Fi, Bluetooth).

All oneM2M devices/gateways/infrastructures do not have higher functions and may have mandatory functions and some optional functions from among the corresponding functions.

The term “resource” in the M2M communication system may be used to construct and express information in the M2M communication system, and may indicate all kinds of things capable of being identified by URI. The resource may be classified into a general resource, a virtual resource, and an announced resource. Respective resources can be defined as follows.

Virtual Resource: The virtual resource may trigger specific processing, and/or may perform retrieving of the result. The virtual resource is not permanently contained in CSE.

Announced Resource: The announced resource is a resource contained in the resource CSE connected to the announced (or notified) original resource. The announced resource may maintain some parts of the characteristics of the original resource. The resource announcement may facilitate the resource searching or discovery. The announced resource contained in the remote CSE is not present as a child of the original resource in the remote CSE, or may be used to generate child resources instead of the announced child of the original resource.

General resource: If this resource is not designated as the virtual or announced resource, the corresponding resource is a general resource.

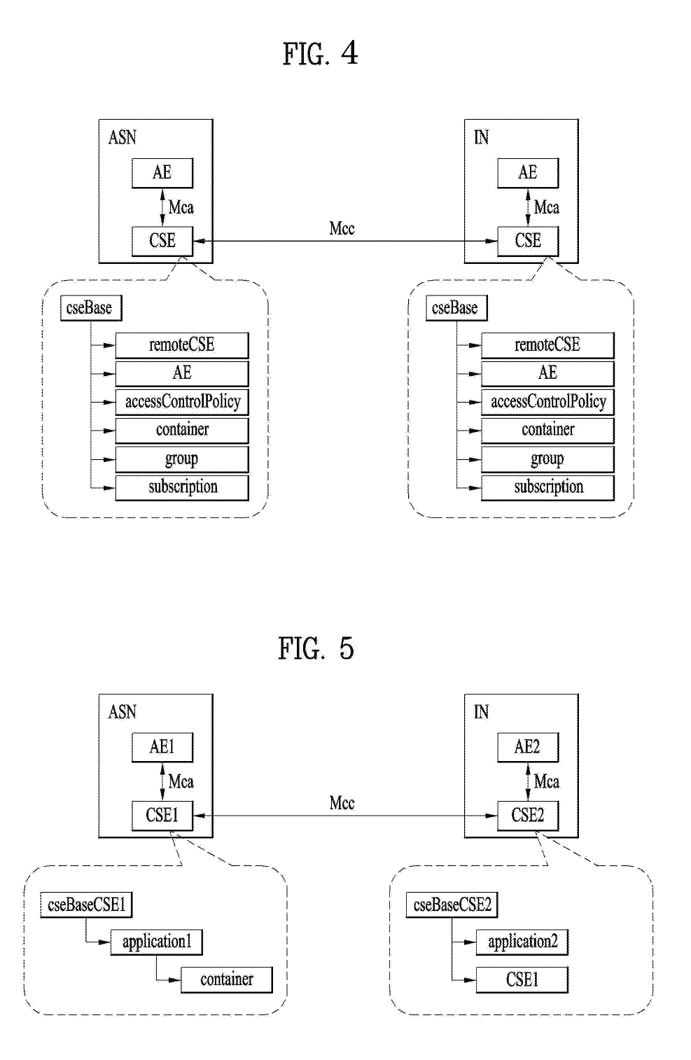

FIG. 4 illustrates structures of resources present in an M2M application service node and an M2M infrastructure node.

The M2M architecture defines various resources. M2M services for registering applications and reading sensor values can be performed by operating the resources. The resources are configured in one tree structure and may be logically connected to the CSE or stored in the CSE to be stored in M2M devices, M2M gateways, network domains and the like. Accordingly, the CSE can be referred to as an entity that manages resources. The resources have a <cseBase> as a tree root. Representative resources are described below.

<cseBase> resource: this is a root resource of oneM2M resources configured in a tree and includes all other resources.

<remoteCSE> resource: this belongs to <cseBase> resource and includes information on other CSE being connected or registered to corresponding CSE.

<AE> resource: this is a resource that is lower than <cseBase> or <remoteCSE> resource, and stores information on applications registered (connected) with the corresponding CSE when present under <cseBase> resource, and stores information on applications registered with other CSEs (in the name of CSE) when present under <remoteCSE> resource.

<accessControlPolicy> resource: this stores information associated with access rights to specific resources. Authentication is performed using access rights information included in this resource.

<container> resource: this is a resource that is lower than containers and stores data per CSE or AE.

<group> resource: this is a resource that is lower than groups and provides a function of grouping a plurality of resources and simultaneously processing the grouped resources.

<subscription> resource: this is a resource that is lower than subscriptions and executes a function of announcing a state change such as a resource value change through notification.

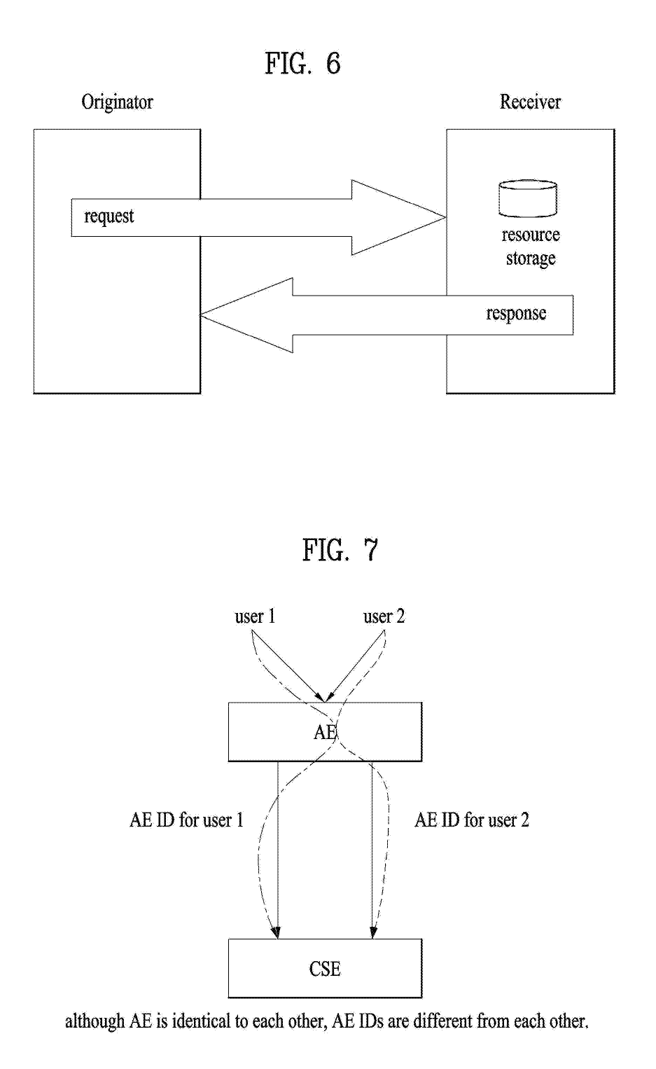

FIG. 6 illustrates structures of resources present in an M2M application service node (e.g. M2M device) and an M2M infrastructure node.

A description will be given of a method by which an AE (application 2) registered with the M2M infrastructure node reads a value of a sensor of the M2M device. The sensor refers to a physical device, in general. An AE (application 1) present in the M2M device reads a value from the sensor and stores the read value in the form of a container resource in a CSE (CSE 1) in which the AE (application 1) has registered. To this end, the AE present in the M2M device needs to be pre-registered with the CSE present in the M2M device. Upon completion of registration, registered M2M application related information is stored in the form of cseBaseCSE1/application1 resource, as shown in FIG. 5.

When the sensor value is stored, by the AE present in the M2M device, in a container resource lower than the cseBaseCSE1/application1 resource, the AE registered with the infrastructure node can access the corresponding value. To enable access, the AE registered with the infrastructure node also needs to be registered with a CSE (CSE 2) of the infrastructure node. Registration of the AE is performed by storing information about application 2 in cseBaseCSE2/application2 resource as application 1 is registered with CSE L Application 1 communicates with application 2 via CSE 1 and CSE 2 instead of directly communicating with application 2. To this end, CSE 1 needs to be pre-registered with CSE 2. When CSE 1 registers with CSE 2, CSE 1 related information (e.g. Link) is stored in the form of <remoteCSE> resource lower than cseBaseCSE2 resource. That is, <remoteCSE> provides a CSE type, access address (IP address and the like), CSE ID, and reachability information about the registered CSE.

the service capability related to one embodiment of the present invention may be defined as a resource type, and various resource types shown in the following table are present.

TABLE 1

| Resource | Short | Child Resource | |
|---|---|---|---|
| Type | Description | Types | Parent Resource Types |
| CSEBase | The structural | remoteCSE, node, | None |
| | root for all the | application, | |
| | resources that | container, group, | |
| | are residing on a | accessControlPolicy, | |
| | CSE. It shall | subscription, | |
| | store information | mgmtObj, mgmtCmd, | |
| | about the CSE | locationPolicy, | |
| | itself | statsConfig | |
| group | Stores | fanOutPoint | Application, remoteCSE, |
| | information | subscription | CSEBase |
| | about resources | | |
| | of the same type | | |
| | that need to be | | |
| | addressed as a | | |
| | Group. | | |
| | Operations | | |
| | addressed to a | | |
| | Group resource | | |
| | shall be executed | | |
| | in a bulk mode | | |
| | for all members | | |
| | belonging to the | | |
| | Group | | |
| locationPolicy | Includes | subscription | CSEBase |
| | information to | | |
| | obtain and | | |
| | manage | | |
| | geographical | | |
| | location. It is | | |
| | only referred | | |
| | from container, | | |
| | the | | |
| | contentInstances | | |
| | of the container | | |
| | provides location | | |
| | information | | |
| remoteCSE | Represents a | application, | CSEBase |
| | remote CSE for | container, group, | |
| | which there has | accessControlPolicy, | |
| | been a | subscription, | |
| | registration | mgmtObj, | |
| | procedure with | pollingChannel, node | |
| | the registrar CSE | | |
| | identified by the | | |
| | CSEBase | | |
| | resource | | |
| subscription | Subscription | schedule | accessControlPolicy, |
| | resource | | application, cmdhBuffer, |
| | represents the | | cmdhDefaults, |
| | subscription | | cmdhEcDefParamValues, |
| | information | | cmdhDefEcValue, |
| | related to a | | cmdhLimits, |
| | resource. Such a | | cmdhNetworkAccessRules, |
| | resource shall be | | cmdhNwAccessRule, |
| | a child resource | | cmdhPolicy, container, |
| | for the | | CSEBase, delivery, |
| | subscribe-to | | eventConfig, execInstance, |
| | resource | | group, contentInstance, |
| | | | locationPolicy, mgmtCmd, |
| | | | mgmtObj, |
| | | | m2mServiceSubscription, |
| | | | node, nodeInfo, |
| | | | parameters, remoteCSE, |
| | | | request, schedule, |
| | | | statsCollect, statsConfig |
| container | Shares data | container, | application, container, |
| | instances among | contentInstance, | remoteCSE, CSEBase |
| | entities. Used as | subscription, | |
| | a mediator that | | |
| | takes care of | | |
| | buffering the | | |
| | data to exchange | | |
| | “data” between | | |
| | AEs and/or | | |
| | CSEs. | | |

Each resource type may be located below the parent resource type of the corresponding resource type, and may have a child resource type. In addition, each resource type may have attributes, and actual values may be stored in the attributes. Table 2 shows attributes of the <CSEBase> resource. The attributes used to store the actual values may always be set to the value of 1 through multiplicity or may be selectively set to the values (‘0 . . . 1’) through multiplicity. In addition, the corresponding attributes may be established according to RO (Read Only), RW (Read and Write), WO (Write Only) according to characteristics generated when the corresponding attributes are generated.

TABLE 2

| Attribute Name of | | | |
|---|---|---|---|
| <CSEBase> | Multiplicity | RW/RO/WO | Description |
| resourceType | 1 | RO | Resource Type. This Write |
| | | | Once (at creation time then |
| | | | cannot be changed) |
| | | | resourceType attribute |
| | | | identifies the type of |
| | | | resources. Each resource |
| | | | shall have a resourceType |
| | | | attribute. |
| creationTime | 1 | RO | Time/date of creation of |
| | | | the resource. This attribute |
| | | | is mandatory for all |
| | | | resources and the value is |
| | | | assigned by the system at |
| | | | the time when the resource |
| | | | is locally created. Such an |
| | | | attribute cannot be |
| | | | changed. |
| lastModifiedTime | 1 | RO | Last modification time/date |
| | | | of the resource. This |
| | | | attribute shall be |
| | | | mandatory and its value is |
| | | | assigned automatically by |
| | | | the system each time that |
| | | | the addressed target |
| | | | resource is modified by |
| | | | means of the UPDATE |
| | | | operation. |
| accessControlPolicyIDs | 0 . . . 1 (L) | RW | The attribute contains a list |
| | | | of identifiers (either an ID |
| | | | or a URI depending if it is |
| | | | a local resource or not) of |
| | | | an <accessControlPolicy> |
| | | | resource. |
| labels | 0 . . . 1 | RW | Tokens used as keys for |
| | | | discovering resources. This |
| | | | attribute is optional and if |
| | | | not present it means that |
| | | | the resource cannot be |
| | | | found by means of |
| | | | discovery procedure which |
| | | | uses labels as key |
| | | | parameter of the discovery. |
| cseType | 0 . . . 1 | WO | Indicates the type of CSE |
| | | | represented by the created |
| | | | resource. Mandatory for an |
| | | | IN-CSE, hence multiplicity |
| | | | (1). Its presence is subject |
| | | | to SP configuration in case |
| | | | of an ASN-CSE or a MN- |
| | | | CSE. |
| CSE-ID | 1 | WO | The globally unique CSE |
| | | | identifier. |
| supportedResourceType | 1 | RO | List of the resource types |
| | | | which are supported in |
| | | | CSE. This attribute |
| | | | contains subset of resource |
| | | | types listed in clause 9.2. |
| | | | For each supported |
| | | | resourceType this attribute |
| | | | indicates the supported |
| | | | optional attributes also. |
| pointOfAccess | 0 . . . 1 (L) | RW | Represents the list of |
| | | | physical addresses to be |
| | | | used by remote CSEs to |
| | | | connect to this CSE (e.g. IP |
| | | | address, FQDN). This |
| | | | attribute is used to |
| | | | announce its value to |
| | | | remote CSEs. |
| nodeLink | 0 . . . 1 | RO | A reference (URI) of a |
| | | | <node> resource that stores |
| | | | the node specific |
| | | | information. |
| notificationCongestionPolicy | 0 . . . 1 | RO | This attribute applies to |
| | | | CSEs generating |
| | | | subscription notifications. |
| | | | It specifies the rule which |
| | | | is applied when the storage |
| | | | of notifications for each |
| | | | subscriber (an AE or CSE) |
| | | | reaches the maximum |
| | | | storage limit for |
| | | | notifications for that |
| | | | subscriber. E.g. Delete |
| | | | stored notifications of |
| | | | lower |
| | | | notificationStoragePriority |
| | | | to make space for new |
| | | | notifications of higher |
| | | | notificationStoragePriority, |
| | | | or delete stored |
| | | | notifications of older |
| | | | creationTime to make |
| | | | space for new notifications |
| | | | when all notifications are |
| | | | of the same |
| | | | notificationStoragePriority. |

As shown in FIG. 4 or 5, the resource for use in the M2M system may be represented by a tree structure, and the root resource type may be denoted by <CSEBase>. Therefore, the <CSEBase> resource type must be present only when the common service entity (CSE) is present.

FIG. 4 is a conceptual diagram illustrating a general communication flow located at Mca and Mcc reference points. The M2M system operation is carried out on the basis of data exchanging. For example, in order to allow a first device to transmit or perform a command for stopping a specific operation of a second device, the first device must transmit the corresponding command (configured in a data form) to the second device. In the M2M system, data can be exchanged using the request and response messages during communication between the application (or CSE) and another CSE.

The request message may include the following information.
op: “op” means the shape of an operation to be carried out. (This information may be selected from among Create, Retrieve, Update, Delete, and Notify.)
to: “to” means an ID (i.e., ID of the receiver) of an entity scheduled to receive the request.
fr: “fr” means an ID of a calling user (i.e., call originator) who generates the request.
ri: “ri” means an ID (i.e., ID used to discriminate the request message) of the request message
mi: “mi” means additional information (i.e., meta information) regarding the corresponding request.
cn: “en” means content of resources to be transmitted.

The response message may include the following information. If the corresponding request message is successfully processed, the response message may include the following information.
to: “to” means an ID of a calling user (i.e., a call originator) who generates the request message.
fr: “fr” means an ID of a called person (i.e., a call receiver) who receives the request message.
ri: “ri” means an ID of the request message used to identify the ID of the request message.
mi: “mi” means additional information (i.e., meta information) regarding the corresponding request.
rs: “rs” means the processed result (for example, Okay, Okay and Done, Okay and in progress) of the request message.
ai: “ai” means additional information.
cn: “cn” means content of resources to be transmitted (only the resultant value (rs) can be transmitted.)

If the request message processing is failed, the response message may include the following information.
to: “to” means an ID of a calling user (i.e., a call originator) who generates the request message.
fr: “fr” means an ID of a called person (i.e., a call receiver) who receives the request message.
ri: “ri” means an ID of the request message (so as to identify the ID of the request message).
mi: “mi” means additional information (i.e., meta information) regarding the corresponding request.
rs: “rs” means the processed result (for example, Not Okay) of the request message.
ai: “ai” means additional information.

As described above, the response message may include the above-mentioned information.

AE ID (Application Entity Identifier)

An application entity identifier (AE ID) uniquely identifies an AE existing on an M2M node or an AE making a request for an interaction with an M2M node. The AE IE should identify an application entity for the purpose of all interactions in an M2M system. For example, the AE ID corresponds to an ID for identifying an application installed in an M2M device. The AE ID is not an ID for identifying a specific application type (e.g., a temperature sensing application A) but an ID for identifying a specific application a installed in a specific M2M device.

An M2M service provider is responsible for making an AE ID to be globally unique and the AE ID should include an application ID.

App-ID (Application Identifier)

An App-ID is identical to an application name and the App-ID is not guaranteed to be globally unique. For example, the App-ID corresponds to an ID for identifying an application installed in an M2M device and the App-ID corresponds to an ID for identifying a specific application type (e.g., a temperature sensing application A).

The App-ID can be supported by a single or multiple registration authentication entities.

CSE-ID

A CSE should be identified by a globally unique identifier when the CSE is instantiated in an M2M node in an M2M system. A CSE-ID should identify a CSE for the purpose of all interactions to/from the CSE in an M2M system.

M2M node ID

An M2M node hosting a CSE and/or application(s) should be identified by a globally unique identifier.

An M2M system should make an M2M service provider configure a CSE-ID and an M2M node ID by a same value.

An M2M node ID makes an M2M service provider bind a CSE-ID with a specific M2M node.

An example of allocating a globally unique M2M node ID includes the use of OID (object identity) and IMEI.

Access Control for Multiple Users

According to a related art, an AE or a CSE accesses a resource of a specific CSE and uses an identifier (ID) of the AE or the CSE when accessing the resource. The AE and the CSE correspond to an entity identified on an M2M system as an M2M entity and can perform access control as well.

Yet, if a plurality of users use the AE, each of a plurality of the users may differentiate resource access control of the CSE. For example, it may consider a case that the AE corresponds to a device shared by many users or a device installed in a public facility.

More specifically, according to the related art, in case of accessing a specific resource, whether or not it is able to access the resource is determined by an ID of a user instead of an AE ID. In this case, the resource access control is feasible when a service provider of an AE and a service provider of a resource storage are identical to each other. Or, the access control can be performed by a contract. In particular, the resource storage corresponds to an entity capable of recognizing an ID of a user.

Yet, a problem occurs when a service provider of an AE and a service provider of a resource storage (e.g., a CSE hosting a resource) are not identical to each other or there is no contract. In particular, when a user is under contract with an AE, the AE is under contract with a resource storage but the user is not under contract with the resource storage, a problem occurs. For example, in case of a treadmill in a fitness center, if it is assumed that there is an AE configured to store records based on an ID of a user and show the records to the user and the AE of the treadmill stores the records in a resource storage of an M2M system in a manner of being connected with the M2M system, an interaction with the user is recognized by the AE only and the AE stores a value in the resource storage based on an ID of the AE.

Hence, although a different user uses the treadmill, since the AE is identical to each other, the resource storage performs an access control based on an AE ID while failing to recognize the different user. For example, if a user using an AE corresponds to a user 1, it may give an authority for updating and retrieving a specific resource (e.g., record information of the user 1) of the CSE to the user 1. On the contrary, when a user using the AE corresponds to a user 2, if the user 2 does not have authority for the resource of the CSE, the CSE is unable to perform access control using an identifier of the AE only. The CSE is able to perform the access control only when the CSE includes information of the user 2 as well as the identifier of the AE. Yet, since user authentication (identifier authentication, e.g., ID/password-based authentication) is terminated in an AE, a user corresponds to an entity incapable of being recognized in an M2M system. In particular, information on a user exists at an AE only. The user information does not exist in an M2M system or the user information is not handled in the M2M system. In the following, a mechanism for enabling an access control to an entity, which is capable of being recognized in an M2M system through identification information of which AE identification information based on user information is newly established or new identification information of which an AE identifier is extended, is explained.

AE ID Differentiation Per User

Since identification information of a user does not exist in a resource hosting CSE, in order to perform an access control different from each other according to a user in the CSE, a different AE ID can be assigned to each user. In particular, although an application instance is identical to each other (an instantiated application, more simply, a specific application installed in a specific M2M device or operating in the specific M2M device), a different ID is assigned according to a user. Hence, a CSE communicating with a corresponding AE or a different AE can be recognized as a different AE according to a user. By doing so, it is able to perform access control for a specific user through an AE ID.

An AE ID can include an application identifier and an identifier capable of uniquely identifying an application instance on a corresponding application. In this case, the application identifier is same irrespective of a user and the identifier capable of identifying the application instance can be differently assigned according to a user.

Or, the AE ID can include not only the application identifier and the identifier capable of identifying the application instance but also an extension identifier. In this case, the application identifier and the identifier capable of identifying the application instance are same irrespective of a user and the extension identifier can be differently assigned according to a user. The extension identifier may be identical to an identifier (i.e., user ID) for identifying a user shared between a user and an AE, by which the present invention may be non-limited. The extension identifier can be uniquely assigned according to a corresponding user.

Although an AE is identical to each other, a destination address of a message transmitted by a different entity to a corresponding AE ID may vary depending on a user.

More specifically, the application ID corresponds to information for identifying an application (e.g., application name) of a corresponding AE. For example, if an M2M device corresponds to a PC (personal computer), a word program or an internet browser program corresponds to the application and an ID assigned to each program corresponds to the application ID.

And, the AE ID corresponds to an ID capable of identifying an application uniquely installed in an M2M device. In particular, if the M2M device corresponds to a PC, although a same application ID is assigned to a word program installed in my PC and a word program installed in a PC of a younger brother, an AE ID for identifying the two programs is different from each other.

Authentication Procedure

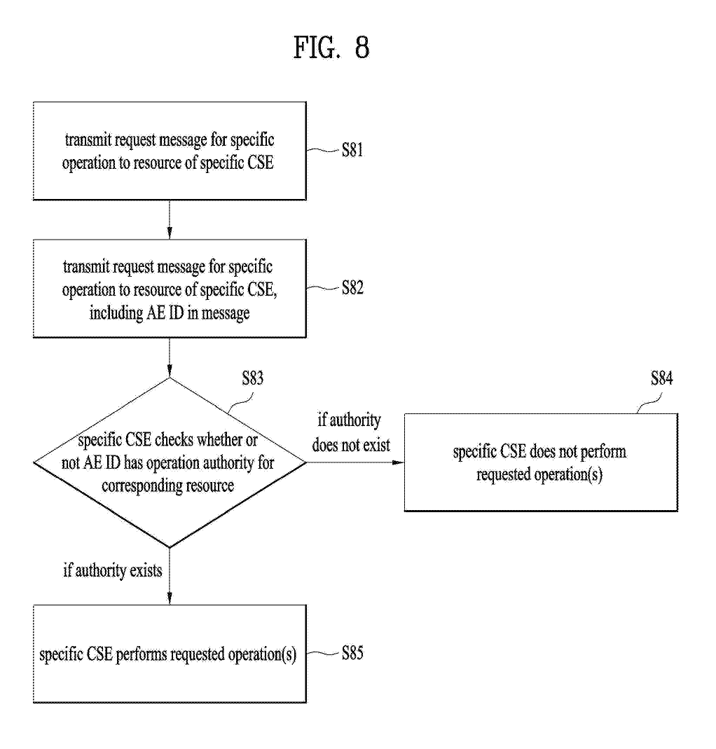

FIG. 8 shows an authentication procedure using an AE ID.

A user can transmit a request message for requesting a specific operation to a resource of a specific CSE via an AE [S81].

The AE can transmit a request message for the operation to the resource of the specific CSE in a manner of including an AE ID corresponding to the user in the request message [S82]. In this case, the AE ID can be transmitted in a manner of being included in a sender ID capable of being used for access control.

The specific CSE can check whether or not the AE ID has an operating authority for the resource [S83]. The resource may include a link related to access control and the link may have a description on an authority for an operation performed by an entity. By doing so, the specific CSE is able to check an authority of an entity on the resource.

In the step S83, if it is determined as the AE ID does not have authority, the specific CSE does not perform the requested operation(s) [S84]. The CSE can deliver information indicating that the CSE does not perform the requested operation(s) due to the lack of authority to the AE.

In the step S83, if it is determined as the AE ID has authority, the specific CSE can perform the requested operation(s) [S84]. The CSE can deliver information indicating that the CSE has performed the operation(s) to the AE.

AE ID Assignment

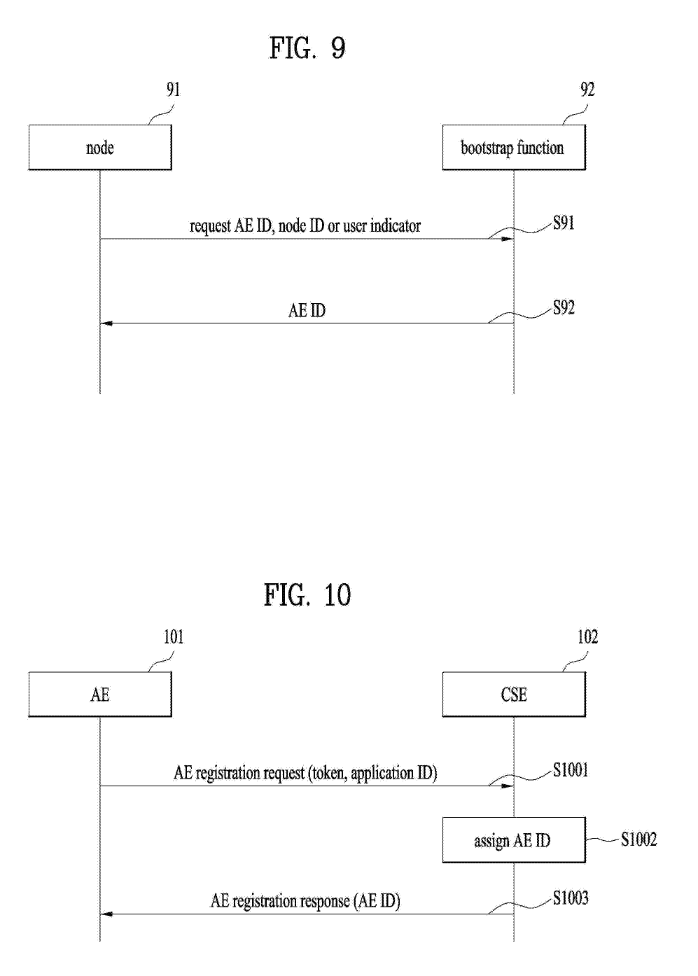

FIG. 9 shows a procedure of assigning an AE ID according to a user in accordance with one embodiment of the present invention.

If a specific node 91 recognizes that it is necessary to receive AE ID assignment (e.g., when an AE recognizes a new user or recognizes that an application ID exists only without an AE ID), the specific node can transmit a message for requesting an AE ID to a bootstrap function 92 [S91]. The specific node may correspond to a CSE or an AE. The bootstrap function may correspond to an entity capable of assigning an AE ID. For example, the bootstrap function may correspond to an M2M bootstrap function, an M2M provisioning server, an M2M service bootstrap function, an application server, an infrastructure node application, a smart card or the like. The request can be transmitted in a manner of being included in a message for requesting overall configuration information of a node/AE such as a node/AE bootstrap, a node/AE configuration provisioning and the like.

And, the message can include an application ID (App-ID), a node ID or a user indicator.

The bootstrap function assigns a unique ID to the AE according to a user and can transmit the assigned ID to the node [S92]. If an identical node ID corresponding to a previously assigned AE ID and an identical app-ID are included in the message of the S91, a node ID can be used for assigning an AE ID identical to the previously assigned AE ID. By doing so, although a corresponding node or an AE lost information on the previously assigned AE ID, the node ID makes the bootstrap function assign an identical AE ID. Although a message including an identical app-ID and a node ID is transmitted to the bootstrap function several times without a user indicator, an identical AE ID can be assigned to the node. Hence, although a corresponding node or an AE is connected/registered with/at a different CSE, it may be able to connect/register the node or the AE with/at the different CSE using an identical AE ID. And, it may be able to bring all information or a part of information set to the AE from a previously connected/registered CSE via the AE ID.

The user indicator is in charge of notifying information indicating that a new user has come, information on whether or not the AE supports multiple users, or an identifier capable of identifying a user. In particular, when the user indicator does not exist or is set with a specific value (e.g., false), if the node makes a request for an identical app-ID, the bootstrap function can transmit an identical AE ID to the node if an identical AE ID value previously assigned to a corresponding AE exists (i.e., if the bootstrap function has the identical AE ID value). If the user indicator exists or is set with a specific value (e.g., true), although the node makes a request for an identical app-ID, the bootstrap function assigns an AE ID different from the app-ID and the AE ID previously assigned to the node and may be able to the transmit the newly assigned AE ID to the node.

When the user indicator includes an identifier capable of identifying a user, if an app-ID identical to an app-ID included in the message, an AE ID assigned to an identical node ID and an AE ID assigned to an identical user indicator exist, the bootstrap function can transmit the AE ID to the node. Or, when the user indicator includes an identifier capable of identifying a user, if an app-ID identical to an app-ID included in the message and an AE ID assigned to an identical user indicator exist, the bootstrap function can transmit the AE ID to the node. The identifier capable of identifying a user may or may not be same with an identifier capable of identifying a user shared between an AE and a user. If the identifier, which is included in the user indicator, capable of identifying a user is different from the identifier capable of identifying the user shared between the AE and the user, an AE, an infrastructure node (IN) AE connected with the AE or an AE server can store a mapping relationship between the identifiers.

Meanwhile, although there is no request for the specific node in the step S91, the bootstrap function can perform the step S92 using a different method.

FIG. 10 shows a procedure of assigning an AE ID according to a user in accordance with a different embodiment of the present invention. The procedure shown in FIG. 10 uses an AE registration procedure.

An AE 101 can transmit a token capable of temporarily indicating a specific user and an AE registration request message including an ID of an application corresponding to the AE to a specific CSE [S1001]. The token may correspond to a value based on user information (e.g., e-mail, address, telephone number, user ID of AE) or information received by the AE from a user.

A CSE 102 performs an authentication procedure on the AE registration request message. If the AE registration request message corresponds to a right request, the CSE can assign an AE ID for the AE [S1002]. In particular, the CSE can assign an AE ID suitable for a specific user based on the token and the application ID.

Subsequently, the CSE can transmit an AE registration response message including the assigned AE ID to the AE [S1003].

In the aforementioned procedure, the CSE can assign an AE ID which is unique according to a token. In particular, although the application ID included in at least two or more AE registration request messages is identical to each other, if a token is different from each other, an AE ID different from each other can be assigned to the two request messages, respectively.

Subsequently, if an AE registration request message including a token identical to a token associated with a previously assigned AE ID is received, the CSE can assign an AE ID identical to the previously assigned AE ID. Of course, in this case, an application ID identical to an application ID associated with the previously assigned AE ID is included in the AE registration request message. Meanwhile, the AE ID can be restrictively assigned according to a CSE. Hence, it is able to assign an identical AE ID to an identical CSE in response to an AE registration request including an identical token. Or, if a token is used again, the CSE determines it as token overlap and may be able to assign a new AE ID.

The CSE may store a mapping relationship between a token and an AE ID. Or, the CSE can deduct a token from an AE ID based on a relation between an AE ID and a token. And, the AE can manage a mapping relationship between a user and an AE ID or a token. In particular, the CSE is unable to know a relationship between a token and a user, whereas the AE is able to know the relationship between the token and the user. Hence, although the AE and the CSE are managed by a management entity (i.e., company) different from each other, privacy of a user and the like is not informed to the CSE. Hence, it is able to obtain an effect such as security, privacy protection and the like.

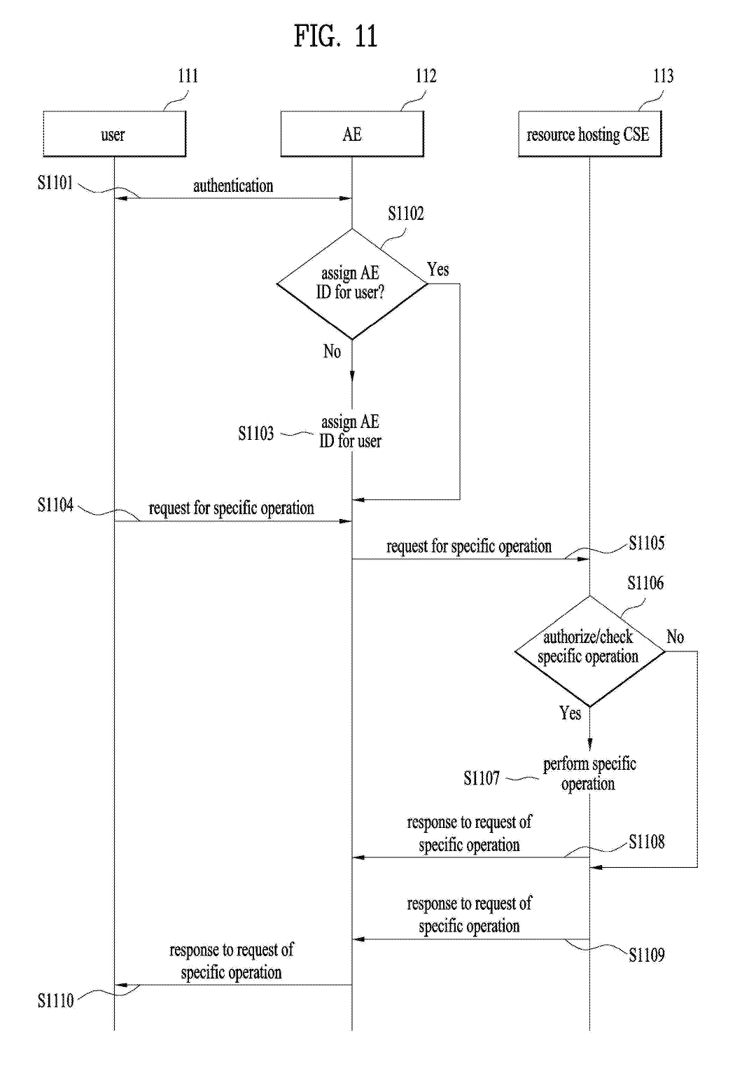

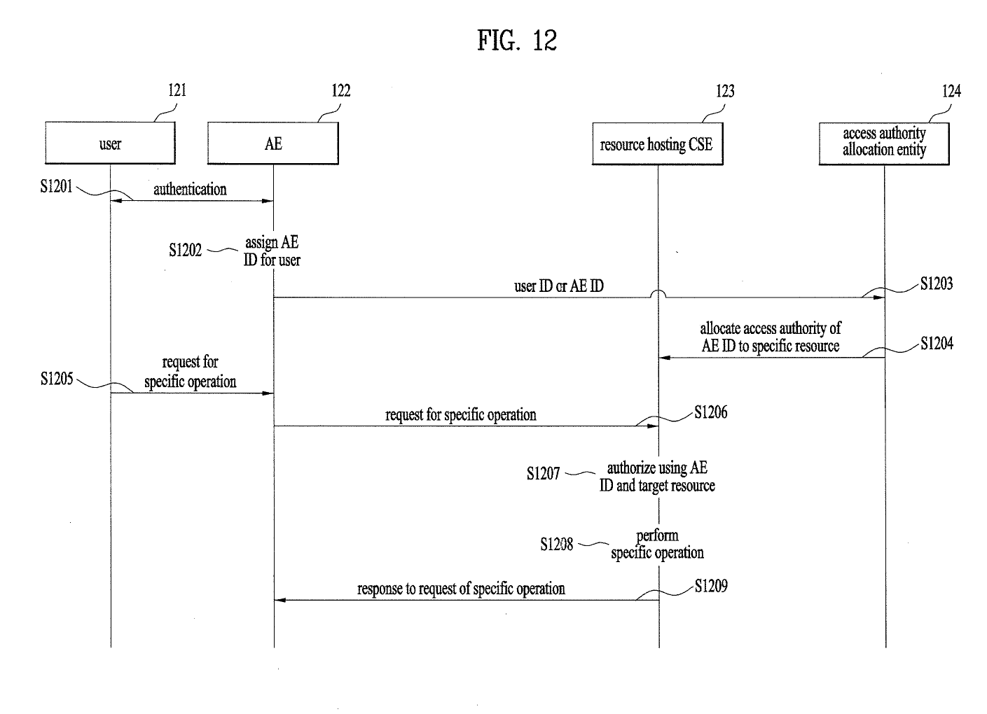

FIG. 11 shows an authentication procedure or an access control procedure performed on a specific resource using an AE ID according to one embodiment of the present invention.

A user 111 and an AE 112 perform authentication (e.g., based on ID/PW). By doing so, the AE can obtain an ID of the user [S1101].

The AE can check whether or not the AE has an AE ID for the user or whether or not there exists an AE ID for the user [S1102].

If the AE does not have the AE ID for the user or the AE determines that the AE ID for the user does not exist, the AE can assign the AE ID for the user [S1103]. The AE ID can be assigned according to the aforementioned procedure.

The user can transmit a request for a specific operation(s) of a specific resource of a specific resource storage (e.g., a resource hosting CSE 113) to the AE [S1104].

The AE can transmit the request for the operation(s) to the specific resource of the resource storage [S1105]. The request can be transmitted in a manner of including an AE ID (e.g., a parameter related to a sender) assigned to the user.

The resource storage can check whether or not the resource has authority for the operation(s) based on an AE ID included in the operation(s) [S1106]. An indicator indicating information on entities authorized for the resource can be included in the resource. Authorization of an entity authorized for an operation(s) can be specified in the information indicated by the indicator. In this case, the information indicating the entities can include an AE ID and information related to the AE ID based on an attribute of the AE ID capable of deducting the AE ID.

If authority for the operation(s) exists for the resource, the resource hosting CSE can perform the operation(s) based on the AE ID [S1107].

If the operation(s) is successfully performed, the resource hosting CSE can transmit a result (e.g., performance success) of the operation(s) to the AE in response to the operation(s) [S1108]. Or, if the operation(s) fails, the resource hosting CSE can transmit a result (e.g., performance failure or authentication failure) of the operation(s) to the AE in response to the operation(s) [S1109].

The AE can transmit a response in response to the request.

Meanwhile, the step S1102 and the step S1103 can be performed between the S1104 and the S1105.

FIG. 12 shows an authentication procedure or an access control procedure performed on a specific resource using an AE ID according to a different embodiment of the present invention.

A user 121 and an AE 122 can perform authentication (e.g., based on ID/PW) [S1201].

The AE can assign a unique AE ID to the user [S1202]. If grouping is performed on the user, the AE ID may be not unique according to a user. The AE ID can be assigned according to the aforementioned procedure.

It is able to transmit a message to an access right allocation entity 124 (e.g., IN-CSE, an M2M server, an entity (e.g., AE) managing an AE of an M2M service provider) to notify that an AE ID is assigned to a specific user [S1203]. The message can be transmitted by the AE or the resource hosting CSE. In this case, it might say that a user ID corresponds to information or a value (e.g., token) capable of recognizing that the access right allocation entity corresponds to the user.

The access right allocation entity can allocate an access authority of the AE ID to specific resources [S1204].

The user can transmit a request for a specific operation(s) of a specific resource of a specific resource storage 123 (e.g., resource hosting CSE) to the AE [A1205].

The AE can transmit the request for the operation(s) to the specific resource of the resource storage [S1206]. The request can be transmitted in a manner of including an AE ID assigned to the user (e.g., in a manner of being configured as a sender-related parameter).

The resource storage can check whether or not the resource has authority for the operation(s) based on the AE ID included in the request for the operation(s) [S1207]. The resource may include an indicator indicating information on entities authorized for the resource. Authorization of an entity authorized for an operation(s) can be specified in the information indicated by the indicator. In this case, if an AE ID has a specific authority, the information indicating the entities can include the AE ID and information related to the AE ID based on an attribute of the AE ID capable of deducting the AE ID.

If the resource storage has authority for the operation(s), the resource storage can perform the operation(s) in response to the resource based on the AE ID [S1208].

Subsequently, the resource storage can transmit a performance result (e.g., performance success) of the operation(s) to the AE in response to the request of the operation(s) [S1209]. Or, the resource storage can transmit a performance result (e.g., performance failure or an authentication failure) to the AE in response to the operation(s).

The steps S1205 to S1209 may consistently occur and the step 1203 or the step S1204 can be delivered by an offline message.

Meanwhile, in FIG. 7 to FIG. 12, “AE”, “CSE” or an operation related to the AE or the CSE can be understood or explained as an operation performed by a node (e.g., AND, ASN, MN or IN) in which the AE or the CSE is installed. And, as mentioned in the foregoing description, the node can also be referred to as an M2M device, an M2M gateway, or an M2M server.

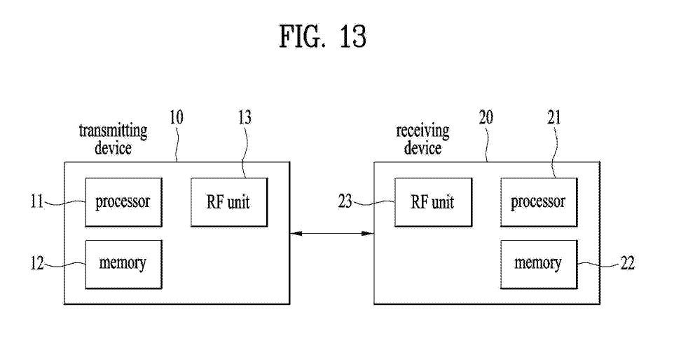

FIG. 13 is a block diagram of a transmitting device 10 and a receiving device 20 configured to implement exemplary embodiments of the present invention. Referring to FIG. 13, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers.

The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

In the embodiments of the present invention, application (entity) or resource related entity etc. may operate as devices in which they are installed or mounted, that is, a transmitting device 10 or a receiving device 20.

The specific features of the application (entity) or the resource related entity etc. such as the transmitting device or the receiving device may be implemented as a combination of one or more embodiments of the present invention described above in connection with the drawings.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The present invention may be used for a wireless communication apparatus such as a terminal, a base station, a server, or other apparatuses.

What is claimed is:

1. A method of assigning a user-specific application identifier in a wireless communication system, the method performed by an M2M (machine-to-machine) device and comprising:
receiving user information from a user;
transmitting a request message including a user-specific token based on the user information and an application identifier to a peer M2M device, the request message being for assigning a user-specific application identifier; and
receiving a response message including the user-specific application identifier, which is assigned based on the user-specific token and the application identifier, from the peer M2M device.

2. The method of claim 1, wherein a unique user-specific application identifier is assigned per a user-specific token included in the request message.

3. The method of claim 1, wherein if a user-specific token identical to a user-specific token associated with a previously assigned user-specific application identifier is included in the request message, a user-specific application identifier identical to the previously assigned user-specific application identifier is assigned.

4. The method of claim 1, wherein if a user-specific token identical to a user-specific token associated with a previously assigned user-specific application identifier is included in the request message, a user-specific application identifier different from the previously assigned UE-specific application identifier is assigned.

5. The method of claim 1, wherein the user-specific application identifier is used for authenticating or access controlling a request from the M2M device.

6. A method of assigning a user-specific application identifier in a wireless communication system, the method performed by an M2M (machine-to-machine) device and comprising the steps of:
receiving a request message including a user-specific token based on user information of a user and an application identifier from a peer M2M device, the request message being for assigning a user-specific application identifier;
assigning the user-specific application identifier based on the user-specific token and the application identifier; and
transmitting a response message including the assigned user-specific application identifier to the peer M2M device.

7. The method of claim 6, wherein a unique user-specific application identifier is assigned per a user-specific token included in the request message.

8. The method of claim 6, wherein if a user-specific token identical to a user-specific token associated with a previously assigned user-specific application identifier is included in the request message, a user-specific application identifier identical to the previously assigned user-specific application identifier is assigned.

9. The method of claim 6, wherein if a user-specific token identical to a user-specific token associated with a previously assigned user-specific application identifier is contained in the request message, a user-specific application identifier different from the previously assigned user-specific application identifier is assigned.

10. The method of claim 6, wherein the user-specific application identifier is used for authenticating or access controlling a request from the M2M device.

11. An M2M (machine-to-machine) device configured to process a request message in a wireless communication system, comprising:
an RF (radio frequency) unit; and
a processor configured to control the RF unit, the processor configured to receive user information from a user, the processor configured to transmit a request message including a user-specific token based on the user information and an application identifier to a peer M2M device, the request message being for assigning a user-specific application identifier, the processor configured to receive a response message including the user-specific application identifier, which is assigned based on the user-specific token and the application identifier, from the peer M2M device.

12. An M2M (machine-to-machine) device configured to process a request message in a wireless communication system, comprising:
an RF (radio frequency) unit; and
a processor configured to control the RF unit, the processor configured to receive a request message including a user-specific token based on user information of a user and an application identifier from a peer M2M device to assign a user-specific application identifier, assign a user-specific application identifier based on the user-specific token and the application identifier, and transmit a response message including the assigned user-specific application identifier to the peer M2M device.
